(19) United States
(12) Patent Application Publication
(10) Pub. No.: US 2021/0188655 A1
(43) Pub. Date: Jun. 24, 2021

(54) METHODS OF SYNTHESIZING METAL OXIDE NANOSTRUCTURES AND PHOTOCATALYTIC WATER TREATMENT APPLICATIONS OF SAME

(71) Applicant: BOARD OF TRUSTEES OF THE UNIVERSITY OF ARKANSAS, Little Rock, AR (US)

(72) Inventors: Tansel Karabacak, Little Rock, AR (US); Ranjitha Kumarapuram Hariharalakshmanan, Little Rock, AR (US)

(21) Appl. No.: 17/190,524

(22) Filed: Mar. 3, 2021

Related U.S. Application Data
(63) Continuation-in-part of application No. 16/011,682, filed on Jun. 19, 2018.
(60) Provisional application No. 62/984,963, filed on Mar. 4, 2020.
(60) Provisional application No. 62/522,384, filed on Jun. 20, 2017.

(51) Int. Cl. C01G 9/02; B01J 35/00; B01J 23/06; C02F 1/68; C02F 1/32

(52) U.S. Cl. CPC C01G 9/02; B01J 35/004; B82Y 40/00; C02F 1/68; C02F 1/32; B01J 23/06

(57) ABSTRACT

This invention relates to a photocatalytic material, a hot water process method to synthesize the photocatalytic material and a method for water treatment with the photocatalytic material. The photocatalytic material includes metal oxide semiconductor nanostructures synthesized from a metallic material by a hot water process, wherein the hot water process comprises treating the metallic material with hot water under a treatment condition for a period of time so as to form the metal oxide semiconductor nanostructures on a surface of the metallic material.

### CROSS-REFERENCE TO RELATED PATENT APPLICATIONS

This application claims priority to and the benefit of, pursuant to 35 U.S.C. 119(e), U.S. Provisional Patent Application Ser. No. 62/984,963, filed Mar. 4, 2020, which is incorporated herein in its entirety by reference.

This application is a continuation-in-part application of U.S. patent application Ser. No. 16/011,682, filed Jun. 19, 2018, which itself claims priority to and the benefit of, pursuant to 35 U.S.C. 119(e), U.S. Provisional Patent Application Ser. No. 62/522,384, filed Jun. 20, 2017, which are incorporated herein in their entireties by reference.

### FIELD OF THE INVENTION

The invention relates generally to nanomaterials, and more particularly to a photocatalytic material containing metal oxide nanostructures, a hot water process method to synthesize the photocatalytic material and a method for water treatment with the photocatalytic material.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

One of the major causes of water pollution worldwide is the release of chemical dye effluents into water. These pollutants are complex and stable organic molecules which are hazardous to the environment and cause serious health risks. The use of metal oxide semiconductors as a photocatalyst for the degradation of organic pollutants in water has received significant attention over the recent years. When light of appropriate wavelength is irradiated on certain metal oxide semiconductor photocatalysts, they produce electron—hole pairs, which in turn react with oxygen and OH molecules present in water to generate reactive oxygen species (ROS). ROS are strong oxidizing agents that can degrade organic pollutant molecules into non-hazardous byproducts. Improving photocatalytic efficiency by using nanostructured materials are also the topic of extensive research due to the characteristics of nanomaterials such as high surface area, enhanced light trapping and charge separation efficiency. However, synthesis methods for producing the metal oxide nanostructures are generally costly, complicated, and hazardous to the environment. In semiconductor photocatalysis, the production of electron-hole pairs in the presence of light energy is the primary step. The generated electrons and holes react with oxygen molecules and OH molecules to form ROS. ROS generation is crucial for the degradation of organic molecules present in water. Over the recent years, nanostructured photocatalysts have been the topic of research due to their advantage of having very high surface area and effective charge separation, which helps in the effective generation of charged particles and ROS. Traditional approaches to fabricate nanostructured surfaces are expensive/complicated (e.g., lithography, chemical vapor deposition, nanocasting, plasma etching, un-scalable (e.g., self-assembly), or environmentally hazardous (e.g., wet chemical etching).

Therefore, a heretofore unaddressed need exists in the art to address the aforementioned deficiencies and inadequacies.

### SUMMARY OF THE INVENTION

One of the objectives of this invention is to develop novel photocatalytic materials containing metal oxide semiconductor nanostructures, hot water treatment methods to produce the metal oxide semiconductor nanostructures for photocatalytic applications, and methods for water treatment with the metal oxide semiconductor nanostructures. It is a low-cost, scalable, high-throughput, and eco-friendly technique. The processes to produce the metal oxide semiconductor nanostructures does not require any special environments/steps such as vacuum, acidic, alkaline solutions, or lithographical processing. The processes are applicable to a wide variety of metallic materials including elemental, alloy, compound metals, or a combination of them with other non-metallic materials. In addition, the processes are applicable to almost any geometry including one dimensional (1D) (e.g., wire, rod, etc.), two dimensional (2D) (e.g., plate, foil, thin film, etc.), and three dimensional (3D) (e.g., powder, pipe, mesh, foam, etc.) metallic materials. Further, the processes can also produce standalone metal oxide nanostructures in the powder form or as a suspension in water.

In one aspect of the invention, the photocatalytic material usably for water treatment, comprises metal oxide nanostructures synthesized from a metallic material by a hot water process, wherein the hot water process comprises treating the metallic material with hot water under a treatment condition for a period of time so as to form the metal oxide nanostructures on a surface of the metallic material.

In one embodiment, the treated metallic material with the metal oxide nanostructures under the hot water process has a surface area to volume ratio that is higher than its pristine surface area to volume ratio of the metallic material.

In one embodiment, the hot water is a liquid phase of water, a gas phase of water, or a combination thereof.

In one embodiment, said treating the metallic material with the hot water comprises immersing the metallic material the hot water, or applying a steam of the hot water at the metallic material.

In one embodiment, the metallic material comprises Ti, Zn, Cu, Al, Fe, Sn, Mg, Mo, Cd, Mn, Co, In, Ni, V, Bi, Ta, Nd, and/or Pb.

In one embodiment, the metal oxide nanostructures are of a semiconductor.

In one embodiment, the metallic material comprises one or more metallic compositions including elemental metals, alloys, compounds, a combination thereof, or a combination of metallic and non-metallic materials.

In one embodiment, the metal oxide nanostructures are of a layer grown on the surface of metallic material, standalone in a powder form, and/or water suspension containing the metal oxide nanostructures released from the surface of metallic material and suspended in the water.

In another aspect of the invention, the method of synthesizing a photocatalytic material comprising metal oxide nanostructures usably for water treatment comprises applying a hot water process to a metallic material, comprising treating the metallic material with hot water under a treatment condition for a period of time so as to form the metal oxide nanostructures on a surface of the metallic material.

In one embodiment, the hot water is a liquid phase of water, a gas phase of water, or a combination thereof.

In one embodiment, said treating the metallic material with the hot water comprises immersing the metallic material the hot water, or applying a steam of the hot water at the metallic material.

In one embodiment, the hot water comprises a type of water with different levels of purity, resistivity, dissolved oxygen, or mineral content.

In one embodiment, the metallic material comprises one or more metallic compositions including elemental metals, alloys, compounds, a combination thereof, or a combination of metallic and non-metallic materials.

In one embodiment, the metal oxide nanostructures are formed on a non-metallic material through a cross-deposition mechanism during the hot water treatment. In one embodiment, the cross-deposition mechanism comprises placing the non-metallic material across a metal substrate during the hot water treatment, wherein molecules that migrate through water and deposit on the metal substrate to form the metal oxide nanostructures deposit on the neighboring non-metallic material and form a layer of the metal oxide nanostructures.

In one embodiment, the treatment condition comprises a temperature in a variety of ranges such that the hot water is liquid water at ambient temperatures, warm water below boiling point, boiling water, or steam at much higher temperatures.

In one embodiment, said treating the metallic material with the hot water is assisted by external physical and chemical factors including radiation, applied electric or magnetic fields, mechanical vibrations, and chemical additives.

In one embodiment, the radiation includes microwave, laser, ultraviolet and infrared light, and the chemical additives include metal salt and metal salt solution.

In one embodiment, the treated metallic material with the metal oxide nanostructures under the hot water process has a surface area to volume ratio that is higher than its pristine surface area to volume ratio of the metallic material.

In yet another aspect of the invention, the method for water treatment includes applying a photocatalytic material to water containing organic pollutants, wherein the photocatalytic material comprises the metal oxide nanostructures synthesized by the above method; and exposing said water to light having ultraviolet (UV) wavelengths for an exposing time so as to photocatalytically degrade the organic pollutants in said water by the metal oxide nanostructures.

In one embodiment, the degradation of the organic pollutants is observed by measuring its absorbance, which is proportional to concentration of the organic pollutants in said water.

In one embodiment, the percentage degradation of the organic pollutants in the presence of the metal oxide nanostructures satisfies with the following equation.

A=((A₀−Aₜ)/A₀)×100,

where A₀ is the absorbance at the initial time, and Aₜ is the absorbance at the exposing time t.

In one embodiment, the metal oxide nanostructures are of a semiconductor.

In one embodiment, the metal oxide nanostructures comprise nanostructures of ZnO, TiO₂, CuO, Fe₂O₃, Al₂O₃, SnO₂, PbO₂, MgO, MoO₃, CdO, MnO₂, CoO₄, In₂O₃, V₂O₅, Bi₂O₃, Ta₂O₅, and/or Nd₂O₃.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 is a schematic representation of a hot water process utilized to produce nanostructured substrate according to one embodiment of the present invention.

FIG. 2 is a schematic representation of the ST process used to fabricate nanostructured substrates according to one embodiment of the present invention.

FIGS. 3A-3D show SEM images of several metals after the hot water process according to embodiments of the present invention, which show the formation of nanostructures.

FIG. 4 shows SEM images of the zinc sheet surface before (control sample; left) and after (right) hot water treatment for 5 hours according to one embodiment of the present invention.

FIG. 5 shows SEM images of the ZnO nanostructures grown on Zn powder by hot water treatment according to one embodiment of the present invention.

FIG. 6 shows XRD spectrum of ZnO nanostructures synthesized by HWT on Zn powder according to one embodiment of the present invention.

FIG. 7 shows SEM images of the ZnO nanostructured powder present in water after hot water treatment of Zn plates according to one embodiment of the present invention.

FIG. 8 shows degradation of methylene blue in ultraviolet (UV) light in the presence of ZnO nanostructures according to one embodiment of the present invention.

FIG. 9 shows degradation of methylene blue in UV-light without the presence of ZnO nanostructures according to one embodiment of the present invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the FIGS. is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing”, or “involve” and/or “involving”, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the phrase “at least one of A, B, and C” should be construed to mean a logical (A or B or C), using a non-exclusive logical OR.

As used herein, the term “high surface area” material refers to the material after the treatments according to this invention having “higher surface area” compared to its starting (pristine) surface area of the material before the treatments. For example, a nanostructured metal oxide layer formed on the surface of a metal foam will increase the overall surface area of the metal foam and make it even a higher surface area of the metallic materials. Another example can be a metal plate having small nanostructures grown on its surface, which will also have a “higher” surface area compared to the starting flat topography of the metal plate.

As used herein, the term “metallic materials” for the hot water process is not limited to specific chemical compositions such as elemental metals, alloys, compounds or any combination of them, or a combination of metallic and none-metallic materials or any physical dimension such as sheet, foil, plate, mesh and powder. The term also includes an ionic compound that can be formed by the neutralization reaction of an acid and a base, or composed of numbers of cations and anions so that the product is electrically neutral such as metals salt and metal salt solutions. Also, a combination of metal salt or metal salt solution with other elemental metals, alloys, compounds or any combination of them, or a combination of metallic and none-metallic materials is covered by the term “metallic materials”.

As used herein, the term “hot water” refers to water having a temperature higher than the freezing temperature of water. The hot water can be in a liquid phase of water, a gas phase of water, or a combination thereof.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

High surface area materials are desired for numerous applications such as catalysis, photonics, optical devices, energy storage, sensors, and biotechnology. Increased surface area can enhance several chemical and physical properties that can improve the functionality, efficiency, and stability of those applications. Nanostructured metallic materials offer the advantage of having high surface-to-volume ratios, which allows the maximum utilization of atoms to be positioned on the surface instead of in the bulk of a metallic material. For example, a nanostructured catalyst can reach superior chemical activity due to the active participation of catalyst atoms available at the high surface provided. In addition, hierarchical micro-nano-structured metallic materials, which are composed of micronized features with nanostructures, possess not only the high surface area and activity of nanomaterials, but also the structural stability and robustness of the bulk material. Thus, they combine the advantages of both nanostructured and bulk metallic materials. Furthermore, with the additional surface are provided by micro-scale features, hierarchical micro-nano-structured metallic materials can achieve even higher surface areas compared to a nanostructured surface alone.

One of the objectives of this invention is to synthesize imparting surfaces with nanometer sized structures that provide photocatalytic properties to surfaces.

In one aspect, the invention relates to hot water treatment methods to produce metal oxide semiconductor nanostructures for photocatalytic applications. A photocatalytic semiconducting material incorporates an electronic structure with a valence and conduction bands separated by a band gap. When it is exposed to light (electromagnetic wave) with an energy equal to or greater than the band gap of the metal oxide semiconductor, electrons are excited from the valence band to the conduction band, leaving holes in the valence band. The electrons and holes in turn react with water and dissolved oxygen in water to produce reactive oxygen species (ROS). ROS react with pollutants in water and degrade them. Hot water treatment process to produce metal oxide nanostructures is a low-cost, scalable, high-throughput, and eco-friendly technique. The approach is a low-temperature process and does not require any special environments/steps such as vacuum, acidic, alkaline solutions, or lithographical processing. The processes described in the disclosure can form a nanostructured metal oxide layer on a base metal. The methods are applicable to a wide variety of metallic materials including elemental, alloy, compound metals, or a combination of them with other non-metallic materials. In addition, the methods are applicable to almost any geometry including one dimensional (1D) (e.g., wire, rod, etc.), two dimensional (2D) (e.g., plate, foil, thin film, etc.), and three dimensional (3D) (e.g., powder, pipe, mesh, foam, etc.) metallic materials. The approach can also produce standalone metal oxide nanostructures in the powder form or as a suspension in water.

In another aspect, the invention provides a photocatalytic surface with nanometer sized metal oxides created by treating the surface of a material with a hot water process. The material include surface-nanostructured materials and poses high surface area. The surface modification processes according to the invention are low-cost, scalable, high-throughput, and eco-friendly processes, which overcome most of the limitations of conventional surface modification processes.

In certain embodiments, the physical surface engineering approach is based on a low-temperature nanostructure fabrication method and does not require any special environments/steps such as vacuum, acidic/alkaline solutions, or lithographical processing. The nanostructuring surface processes can form a nanostructured metal oxide layer on a base material. The methods are applicable to a wide variety of metallic materials including elemental, alloy, or compound metals or combination of them with other non-metallic materials. The methods are applicable to almost any geometry including 1D (e.g., wire, and rod), 2D (e.g., plate, foil, and thin film), and 3D (e.g., powder, pipe, mesh, and foam) metallic materials.

In addition to metallic substrates, any type of surface material including insulators, conductors, semiconductors can be coated with nanostructures of a hot water process through a cross-deposition mechanism, which also named hot water deposition (HWD). Furthermore, the process of the invention can also produce standalone metal oxide nanostructures in the powder form or as a suspension in water.

The hot water process is a metal oxide nanostructure growth technique that results in materials with a high surface area by introducing nanoscale surface roughness. The process involving reaction between hot water (deionized (DI), distilled, or purified) and metallic materials surface. Aspects of the invention utilizes the principle of oxidizing the metallic surface and their responses to hot water to form metal oxides. When a free-oxide metallic surface reacts with hot water, it forms metal oxide nanostructures that have different physical and chemical properties from the original surface. The nanoscale dimension of metal oxide features grew on the surface by these processes considered as physical modification which introduce surface roughness after the treatment processes. Because metal oxides formed by these processes have different chemical properties from the surface of the base metal, it undergoes the chemical modification. Thus, these process results in physical and chemical surface modifications on the metal surface that can be utilized in several applications. From the topographical point of view, the growth of metal oxide nanostructures on a surface results in the development of rough surface that is in nanoscale (nano roughness), thus increasing the surface area of the treated materials comparing to the starting surface of the materials. In the hot water process, the fabrication of metal oxide can take place at either relatively low water temperature (e.g., between 50-95° C.) for liquid water at atmospheric pressure conditions) or at higher temperatures when steam (gas phase of water) is used instead of liquid water. Notwithstanding of the used methods, the treated surface is covered with nanostructures that increase the surface area. Hot water processed-metals form metal oxide surfaces with features in the nanoscale (nanostructured metal oxide) approximately in the range of 25-500 nm on the top of the base metal surface. The geometry and size of nanostructures depend on treatment conditions, such as treatment time, water temperature, dissolved oxygen (DO) in water, and the initial surface roughness of the metal. Nanostructures formed by hot water process provide significantly higher surface areas compared to a pristine metal. Because the process does not involve any chemicals, such as surfactants, reductants, oxidation agents, additives or any byproducts, and takes place at relativity low temperatures, the hot water process is a simple and eco-friendly technique. Since no complicated fabrication processes are involved in the hot water process, such as the need for vacuum environment or plasma, the process is low-cost, scalable, and high-throughput. With almost no restrictions on metal types and their compounds, e.g., alloys or composites, or their geometry, e.g., 1D, 2D or 3D, the process promises an ideal technique to fabricate metallic materials with high surface areas for several applications.

According to embodiments of the invention, two methods: hot water treatment (HWT) and steam treatment (ST), can be used to introduce nanoscale features into the surface. Those two methods are both based on the reaction between hot water with the metallic surface of materials to synthesis metal oxide nanostructures without the need to any types of complicated or expensive fabrication conditions/equipment. In the HWT, the metal is directly immersed in hot water, while for the ST, steam first condenses on the surface of the metal, forms hot water droplets, and reacts with the metal. Each has its own advantages. Overall, the HWT is a single-step process. On the other hand, the ST can provide temperatures beyond the boiling point of water, enhance the kinetics, and therefore shorten the treatment time. The ST can also be more scalable in treating industrial amount and size of materials.

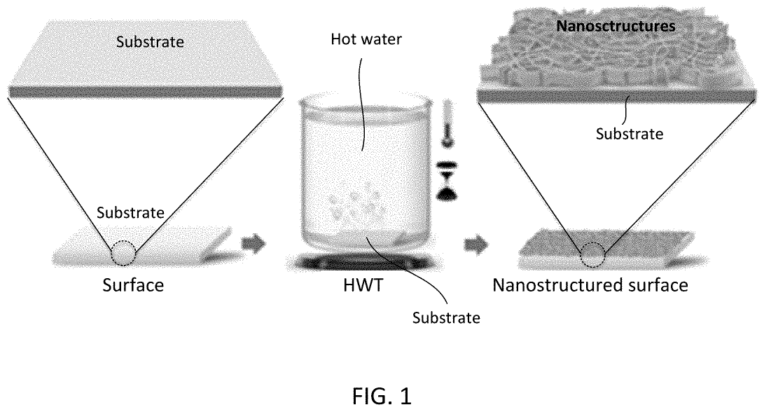

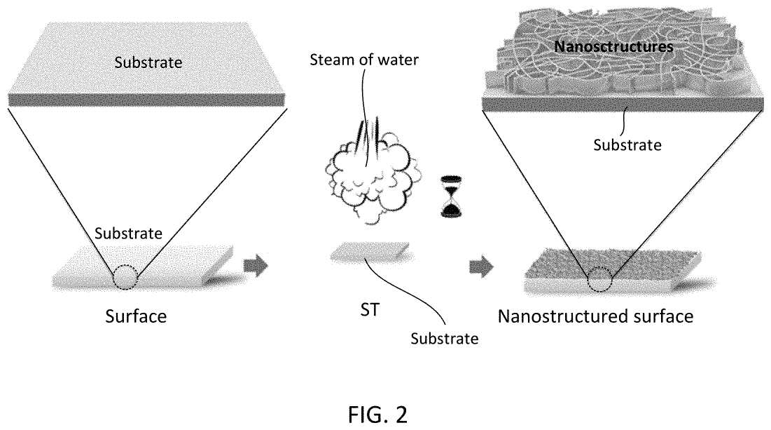

FIGS. 1 and 2 show the HWT and ST processes according to embodiments of the invention, respectively.

In one embodiment shown in FIG. 1, a base metal substrate is disposed in hot water, which involves a reaction between metals and water, such as deionized (DI), distilled, or purified, at temperatures higher than room temperature (usually between 50-95° C.). HWT-metals form rough metal oxide surfaces with features in the nanoscale (nanostructured metal oxide) approximately in the range of 25-500 nm on top of the base metal surface. Nanostructures formed by the HWT provide significantly rough surface with higher surface areas compared to a pristine material. Because the process does not involve any chemicals, such as surfactants, reductants, oxidation agents, additives or any byproducts, and also takes place at relativity low temperatures, the HWT is an eco-friendly technique. Since no complicated fabrication processes are involved in the HWT, such as the need for vacuum environment or plasma, the process is low-cost, scalable, and high-throughput.

In addition, the HWT can produce metal oxide nanostructures on substrates of almost any kind including non-metallic ones through a cross-deposition mechanism. For this, also named hot water deposition (HWD) method, a substrate can be immersed in hot water along with the source metal, which leads to the formation of metal oxide nanostructure emerging from the source metal and deposited on the substrate material. As a cross-deposition method, the hot water process simply involves a source metallic material and a target substrate that are both immersed into hot water. Like the growth of metal oxide nanostructures in the hot water process, a growth mechanism that includes the processes of plugging and surface diffusion. The plugging involves the steps of metal oxide formation on metal-source surface, release of metal oxide molecules from the source, migration through water, and deposition on the target surface. This is followed by surface diffusion of metal oxide molecules that help forming metal oxide nanostructures with smooth crystal facets. In one embodiment, the cross-deposition mechanism comprises placing the non-metallic material across a metal substrate during the hot water treatment, wherein molecules that migrate through water and deposit on the metal substrate to form the metal oxide nanostructures deposit on the neighboring non-metallic material and form a layer of the metal oxide nanostructures. Furthermore, the HWT can produce standalone metal oxide nanostructures in the powder form or as a suspension in water.

As a faster and more scalable alternative to the HWT, the ST shown in FIG. 2 can effectively form metal oxide nanostructures on a materials surface. Different from the HWT, which is limited to the maximum boiling temperature of water, during the ST, water is delivered to the metal surface in the form of vapor that can acquire almost any temperature. Higher temperatures of the steam can allow much faster nanostructure formation kinetics. Steam also does not require the use high purity or DI water. Regular tap water can be evaporated to produce a steam that is free from impurities. During the ST, molecular oxygen from ambient environment can be easily incorporated to the steam that further increases the nanostructure formation kinetics. In addition, the ST can allow spatial control on nanostructuring and easy patterning. For example, using a beam of steam coming out of nozzle, one can do the ST on select regions of a given metal and form a heterogeneous pattern incorporating untreated metal and the ST metal oxide nanostructures. Other than these differences, the ST has all the advantages and similar nanostructure properties of the HWT surfaces under the hot water treatment shown in FIG. 1.

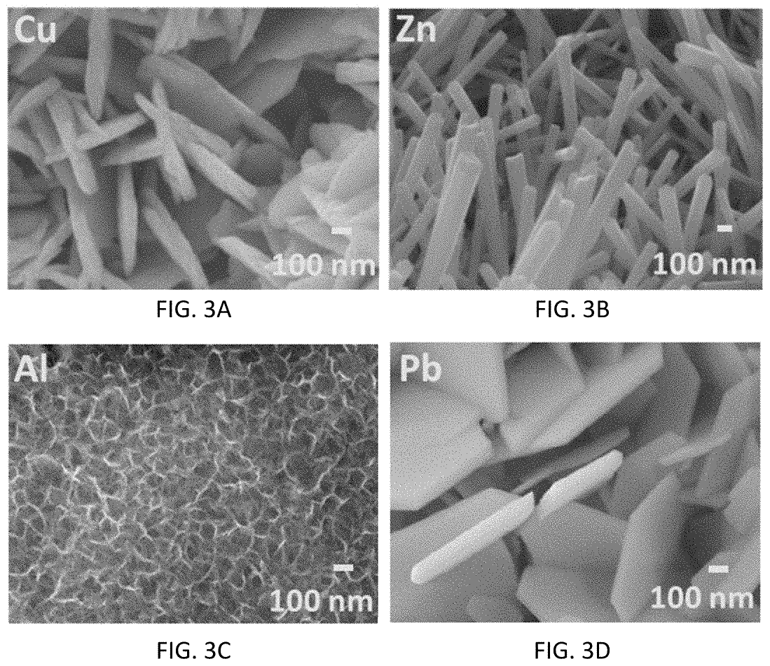

During the hot water process, the surface of a given metal substrate reacts with water at temperatures higher than room temperature to form high surface nanostructured metal oxides. FIGS. 3A-3D show scanning electron microscopy (SEM) images of surfaces of exemplary metals including, but are not limited to, Cu, Zn, Al, and Pb, respectively, after the hot water process. The SEM images show the formation of nanoscale features (nanostructures) in a scale of a few of nanometers. These nanostructures are distributed uniformly on the surface and lead to increasing the surface area and hence enhance its activity.

The invention in certain aspects also relates to the use of nanostructure synthesis techniques (hot water process) to generate surfaces with metal oxide nanostructures with photocatalytic property. The method described above is facile, low-cost, scalable, and eco-friendly. As an example, zinc (Zn) sheet was chosen to demonstrate the physical and chemical surface changes involved and its photocatalytic property by methylene blue degradation test. It should be appreciated that other metallic materials including, but are not limited to, copper (Cu), iron (Fe), aluminum (Al), tin (Sn), magnesium (Mg), molybdenum (Mo), cadmium (Cd), manganese (Mn), cobalt (Co), indium (In), vanadium (V), bismuth (Bi), tantalum (Ta), neodymium (Nd) and lead (Pb) can also be utilized to practice the inventions.

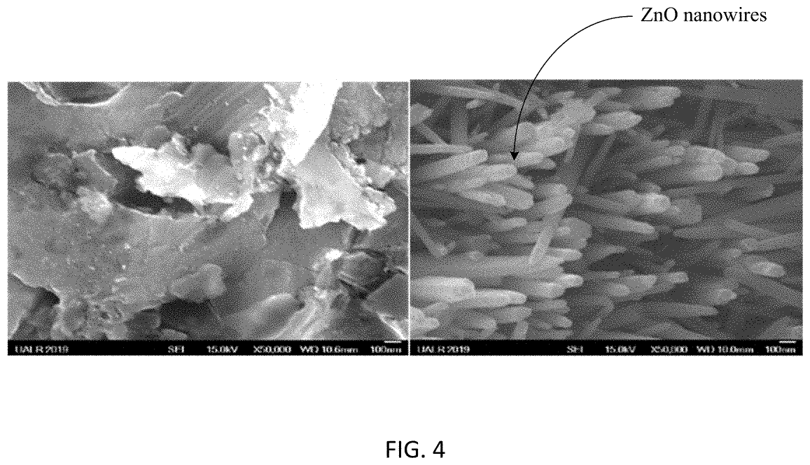

FIG. 4 shows the scanning electron microscopy (SEM) images of Zn sheet (control sample) surface before (left image) and after (right image) the HWT at a temperature of about 75° C. for about 5 hours.

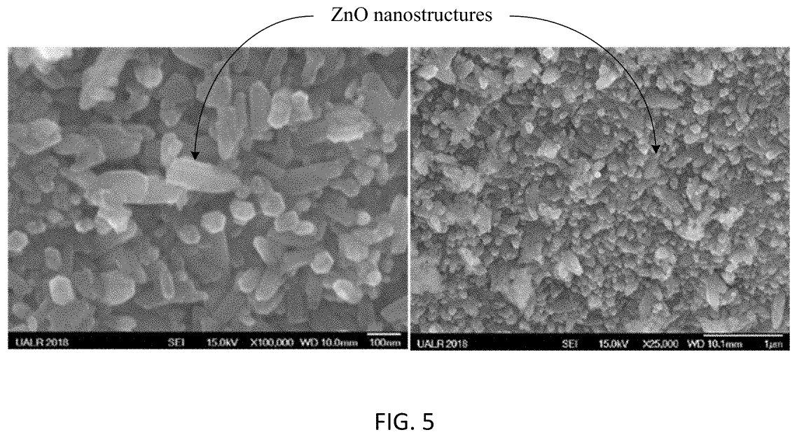

For the control sample, SEM image shows that no nanoscale features (nanostructures) were observed on its surface (FIG. 4, left image with ×50,000 magnification). The surface image of the sample after about 5 hours of the HWT process shows the presence of ZnO nanowires with diameters in a range of about 20-70 nm (FIG. 4, right image with ×50,000 magnification). In some embodiments, the diameter of the ZnO nanowires is in a range of about 10-500 nm. In some embodiments, the diameter of the ZnO nanowires is approximately 300 nm. FIG. 5 shows the SEM images (left image with ×100,000 magnification and right image with ×25,000 magnification) of the zinc powder after the hot water treatment for about 5 hours at a temperature of about 75° C. The SEM images clearly show the ZnO nanostructures such as nanowires grown on the Zn powder by the hot water treatment. The diameter of the ZnO nanowires is about 10-100 nm. In some embodiments, the diameter of the ZnO nanowires is 20-70 nm. In other words, the diamter of ZnO nanowires can range from ˜10 nm up to ˜500 nm. The length of the nanowires can range from a few tens of nanometer to tens of micrometer depending on the hot water treatment parameters and amount of source zinc metal.

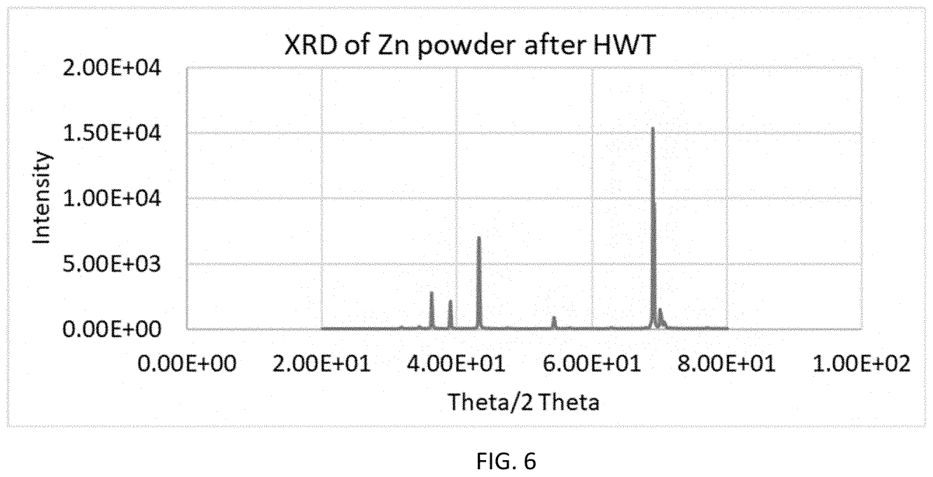

FIG. 6 shows the X-ray diffraction (XRD) spectrum of the Zn powder after the hot water treatment. The peaks at positions 31.75°, 34.40°, and 36.20° can be attributed to the presence of ZnO, (100), (002) and (101), respectively.

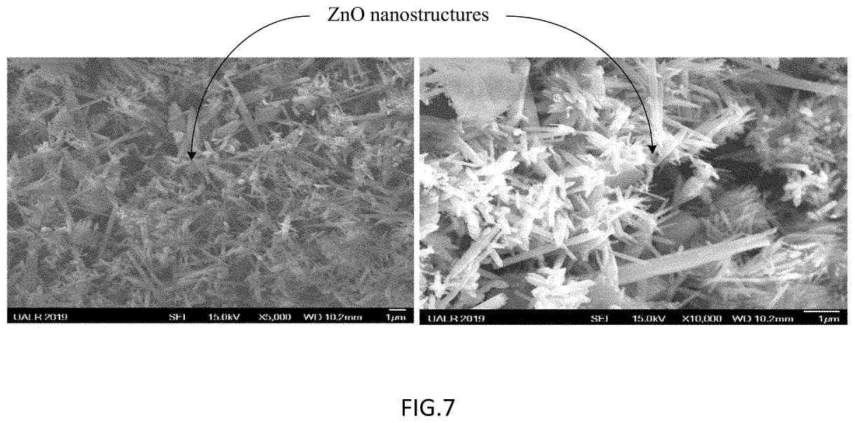

The hot water treatment of zinc plates and/or zinc powder also produces a suspension of the ZnO nanostructures in water. FIG. 7 shows the SEM images (left image with ×5,000 magnification and right image with ×10,000 magnification) of the ZnO powder nanostructures present in the water after the hot water treatment of the Zn plates.

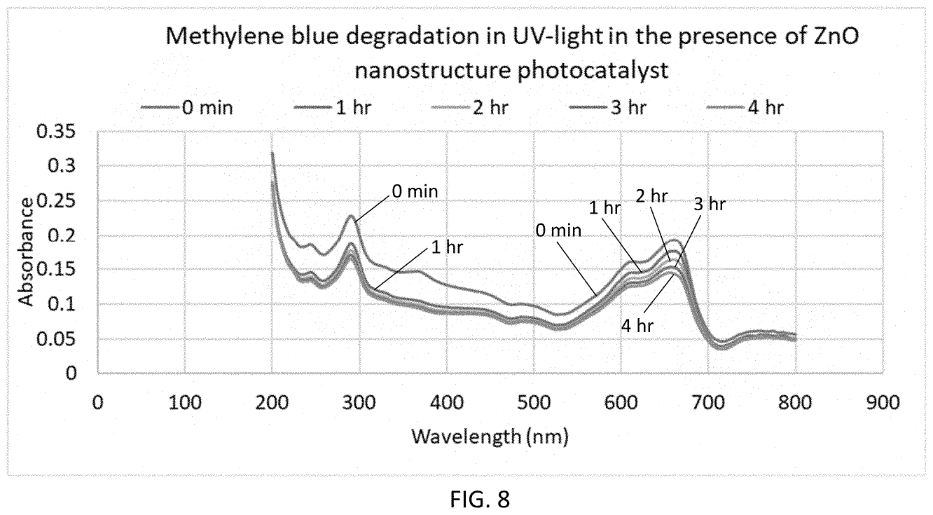

In one embodiment, the ZnO powder nanostructures and water suspension including ZnO nanostructures released and suspended in the water as a result of hot water treatment of Zn plates and Zn powder are used a novel photocatalytic materials for exemplary photocatalytic degradation studies, and methylene blue was used as a model organic pollutant. The organic pollutant in water and/or wastewater may include one or more of dye, humic substances, phenolic compounds, petroleum, surfactants, pesticides, and pharmaceuticals, organic solvents, phthalates, hydrocarbons, esters, alcohols, volatile, semi-volatile and non-volatile chlorinated organic pollutants, microorganisms, etc. In the exemplary example, the ZnO nanostructure suspension was mixed with methylene blue and exposed it to UV light. The degradation of methylene blue was observed by measuring its absorbance values (A) using a UV-visible spectrophotometer over a period of about four hours, as shown in FIG. 8, which illustrates the degradation of methylene blue in UV-light in the presence of the ZnO nanostructures. The absorbance is directly proportional to concentration of methylene blue according to the Beer-Lambert law. The percentage degradation of methylene blue in the presence of the ZnO photocatalyst satisfies with the following equation.

A=((A₀−Aₜ)/A₀)×100,

where A₀ is the absorbance at the initial time, and Aₜ is the absorbance at a given time ‘t’. In the exemplary experiment shown in FIG. 8, the percentage degradation was measured at the time “t” equals to about 1 hr, 2 hr, 3 hr, and 4 hr, respectively. An about 25% degradation of methylene blue in the presence of the ZnO nanostructures was observed at about 4 hr.

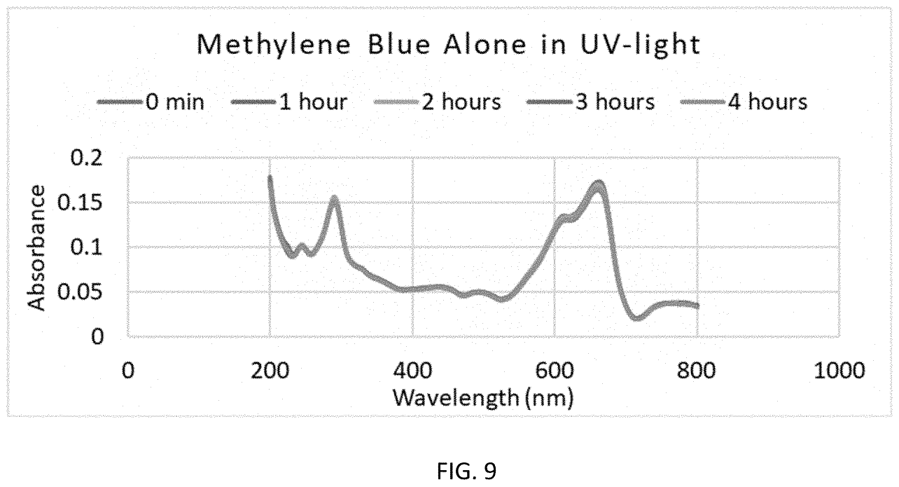

As a control experiment, methylene blue alone in water without the presence of ZnO nanostructures was also exposed to UV light for the same periods (i.e., 1 hr, 2 hr, 3 hr, and 4 hr), and no significant decrease in its concentration was observed, as shown in FIG. 9. These results indicate that the hot water treatment method presents a very cost-effective, scalable, and eco-friendly method for the synthesis of metal oxide nanostructures for photocatalytic water treatment applications.

Alternative Water and Heat Sources: Water is the main element in physical surface modification methods of the HWT, which can be used to achieve the surface nanostructuring of materials according to the invention. In an exemplary HWT process, water with high resistivity, low conductivity, and high purity is preferred. However, water of poorer qualities of these properties such as tap water, mineral water, or even water from lakes, rivers, and sea as an alternative can be used for the HWT and can further lower the fabrication costs of the nanostructuring process according to the invention. In addition, the kinetics of the hot water process and therefore nanostructure growth rates can be enhanced by incorporating tools/conditions that further enhance the effective temperature of the base porous/powder material. For example, microwave (e.g., microwave-assisted HWT), high pressure (HWT in a high-pressure container), and infrared light heating (IR-assisted ST or HWT) can be also utilized during the hot water process according to embodiments of the invention.

Alternative Base Materials: Metallic surfaces of materials made of pure elemental metals, alloys, and/or compounds are the best candidate materials that can directly acquire a nanostructured surface as described above. In addition, any other compositions made by combination of them with other non-metallic materials such as carbon, silicon, polymers can also be used to form a nanostructured surface. As another alternative, any type of surface material including insulators, conductors, semiconductors like glass, polymer, silicon, graphene can be coated with nanostructures of the HWT process through a cross-deposition mechanism. For example, a non-metallic surface can be placed across a metal plate during the HWT. The molecules that migrate through water and deposit on a metal substrate to form nanostructures can also deposit on the neighboring non-metallic surface and can form a layer of HWT-nanostructures. This process is also named hot water deposition (HWD).

Activation Methods: Nanostructure formation kinetics can be enhanced by activating the surface with pretreatment methods such as acid dipping (e.g., HF, HCL, and HNO₃) or plasma exposure. Chemically modified metallic surfaces can incorporate higher number of metal ions that can speed up the fabrication process.

Briefly, aspects of the invention relates to a photocatalytic material, a hot water process method to synthesize the photocatalytic material and a method for water treatment with the photocatalytic material, which have, among other things, the following key features.

Among other things, advantages of the invention include, but are not limited to:
Metal oxide semiconductor nanostructures on base metal surfaces with photocatalytic property is synthesized by a low-cost, scalable, fast, and environment-friendly hot water process.
How water process can be assisted with other tools/conditions, including microwave (e.g., microwave-assisted HWT), high pressure (HWT in a high-pressure container), and infrared light heating (IR-assisted ST or HWT), in order to enhance kinetics/thermodynamics of the nanostructuring mechanisms on the base material.
Hot water process can use a wide variety of water including DI water and purified water, as well as water of poorer quality but lower cost including tap water, mineral water, or even water from lakes, rivers, and sea as alternatives, which further lower the fabrication costs of nanostructuring step of this invention.
Base materials to be used for hot water process can be made of a wide range of materials including pure elemental metals, alloys, compounds, combination of these with non-metallic materials, which can also be used to form a nanostructured surface.
As another alternative, any type of base material including insulators, conductors, semiconductors can be coated with nanostructures of hot water process through a cross-deposition mechanism. For example, a non-metallic material can be placed across a metal plate during the HWT. The molecules that migrate through water and deposit on metal substrate to form nanostructures can also deposit on the neighboring non-metallic material and can form a layer of the HWT-nanostructures. This process is also named hot water deposition (HWD).
Hot water process is applicable to almost any 3D material such as powder, pipe, mesh, or foam that can be used for photocatalytic water treatment applications.
Hot water process can also produce standalone metal oxide nanostructures in the powder form or as a suspension in water.
The methods of this invention can produce high-surface-area photocatalytic materials using a simpler, lower-cost, lower-temperature, more scalable, high-throughput, and more ecofriendly synthesis process compared to other conventional methods.

These advantages make the invention suitable for the industrial applications including, but are limited to waste water treatments, waste water remediation, water purification, and industrial waste water treatment (e.g., chemical industry, gas/oil, textile/wool industry, agriculture).

These and other aspects of the invention are further described below.

In one aspect of the invention, the photocatalytic material usably for water treatment, comprises metal oxide nanostructures synthesized from a metallic material by a hot water process, wherein the hot water process comprises treating the metallic material with hot water under a treatment condition for a period of time so as to form the metal oxide nanostructures on a surface of the metallic material.

In one embodiment, the treated metallic material with the metal oxide nanostructures under the hot water process has a surface area to volume ratio that is higher than its pristine surface area to volume ratio of the metallic material.

In one embodiment, the hot water is a liquid phase of water, a gas phase of water, or a combination thereof.

In one embodiment, said treating the metallic material with the hot water comprises immersing the metallic material the hot water, or applying a steam of the hot water at the metallic material.

In one embodiment, the metallic material comprises Ti, Zn, Cu, Al, Fe, Sn, Mg, Mo, Cd, Mn, Co, In, V, Bi, Ta, Nd, and/or Pb.

In one embodiment, the metal oxide nanostructures are of a semiconductor.

In one embodiment, the metallic material comprises one or more metallic compositions including elemental metals, alloys, compounds, a combination thereof, or a combination of metallic and non-metallic materials.

In one embodiment, the metal oxide nanostructures are of a layer grown on the surface of metallic material, standalone in a powder form, and/or water suspension containing the metal oxide nanostructures released from the surface of metallic material and suspended in the water.

In another aspect of the invention, the method of synthesizing a photocatalytic material comprising metal oxide nanostructures usably for water treatment comprises applying a hot water process to a metallic material, comprising treating the metallic material with hot water under a treatment condition for a period of time so as to form the metal oxide nanostructures on a surface of the metallic material.

In one embodiment, the hot water is a liquid phase of water, a gas phase of water, or a combination thereof.

In one embodiment, said treating the metallic material with the hot water comprises immersing the metallic material the hot water, or applying a steam of the hot water at the metallic material.

In one embodiment, the hot water comprises a type of water with different levels of purity, resistivity, dissolved oxygen, or mineral content.

In one embodiment, the metallic material comprises one or more metallic compositions including elemental metals, alloys, compounds, a combination thereof, or a combination of metallic and non-metallic materials.

In one embodiment, the metal oxide nanostructures are formed on a non-metallic material through a cross-deposition mechanism during the hot water treatment. In one embodiment, the cross-deposition mechanism comprises placing the non-metallic material across a metal substrate during the hot water treatment, wherein molecules that migrate through water and deposit on the metal substrate to form the metal oxide nanostructures deposit on the neighboring non-metallic material and form a layer of the metal oxide nanostructures.

In one embodiment, the treatment condition comprises a temperature in a variety of ranges such that the hot water is liquid water at ambient temperatures, warm water below boiling point, boiling water, or steam at much higher temperatures.

In one embodiment, said treating the metallic material with the hot water is assisted by external physical and chemical factors including radiation, applied electric or magnetic fields, mechanical vibrations, and chemical additives.

In one embodiment, the radiation includes microwave, laser, ultraviolet and infrared light, and the chemical additives include metal salt and metal salt solution.

In one embodiment, the treated metallic material with the metal oxide nanostructures under the hot water process has a surface area to volume ratio that is higher than its pristine surface area to volume ratio of the metallic material.

In yet another aspect of the invention, the method for water treatment includes applying a photocatalytic material to water containing organic pollutants, wherein the photocatalytic material comprises the metal oxide nanostructures synthesized by the above method; and exposing said water to light having ultraviolet (UV) wavelengths for an exposing time so as to photocatalytically degrade the organic pollutants in said water by the metal oxide nanostructures.

In one embodiment, the degradation of the organic pollutants is observed by measuring its absorbance, which is proportional to concentration of the organic pollutants in said water.

In one embodiment, the percentage degradation of the organic pollutants in the presence of the metal oxide nanostructures satisfies with the following equation.

A=((A₀−Aₜ)/A₀)×100,

where A₀ is the absorbance at the initial time, and Aₜ is the absorbance at the exposing time t.

In one embodiment, the metal oxide nanostructures are of a semiconductor.

In one embodiment, the metal oxide nanostructures comprise nanostructures of ZnO, TiO₂, CuO, Fe₂O₃, Al₂O₃, SnO₂, PbO, MgO, MoO₃, CdO, MnO₂, CoO₄, In₂O₃, V₂O₅, Bi₂O₃, Ta₂O₅, and/or Nd₂O₃.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

What is claimed is:

1. A photocatalytic material usably for water treatment, comprising:
metal oxide nanostructures synthesized from a metallic material by a hot water process, wherein the hot water process comprises treating the metallic material with hot water under a treatment condition for a period of time so as to form the metal oxide nanostructures on a surface of the metallic material.

2. The photocatalytic material of claim 1, wherein the treated metallic material with the metal oxide nanostructures under the hot water process has a surface area to volume ratio that is higher than its pristine surface area to volume ratio of the metallic material.

3. The photocatalytic material of claim 1, wherein the hot water is a liquid phase of water, a gas phase of water, or a combination thereof,

4. The photocatalytic material of claim 3, wherein said treating the metallic material with the hot water comprises immersing the metallic material in the hot water, or applying a steam of the hot water at the metallic material.

5. The photocatalytic material of claim 1, wherein the metallic material comprises Ti, Zn, Cu, Al, Fe, Sn, Mg, Mo, Cd, Mn, Co, In, Ni, V, Bi, Ta, Nd, and/or Pb.

6. The photocatalytic material of claim 1, wherein the metal oxide nanostructures are of a semiconductor.

7. The photocatalytic material of claim 1, wherein the metallic material comprises one or more metallic compositions including elemental metals, alloys, compounds, a combination thereof, or a combination of metallic and non-metallic materials.

8. The photocatalytic material of claim 1, wherein the metal oxide nanostructures are of a layer grown on the surface of metallic material, standalone in a powder form, and/or water suspension containing the metal oxide nanostructures released from the surface of metallic material and suspended in the water.

9. A method of synthesizing a photocatalytic material comprising metal oxide nanostructures usably for water treatment, comprising:
applying a hot water process to a metallic material, comprising treating the metallic material with hot water under a treatment condition for a period of time so as to form the metal oxide nanostructures on a surface of the metallic material.

10. The method of claim 9, wherein the hot water is a liquid phase of water, a gas phase of water, or a combination thereof.

11. The method of claim 10, wherein said treating the metallic material with the hot water comprises immersing the metallic material in the hot water, or applying a steam of the hot water at the metallic material.

12. The method of claim 9, wherein the hot water comprises a type of water with different levels of purity, resistivity, dissolved oxygen, or mineral content.

13. The method of claim 9, wherein the metallic material comprises one or more metallic compositions including elemental metals, alloys, compounds, a combination thereof, or a combination of metallic and non-metallic materials.

14. The method of claim 13, wherein the metal oxide nanostructures are formed on a non-metallic material through a cross-deposition mechanism during the hot water treatment.

15. The method of claim 14, wherein the cross-deposition mechanism comprises placing the non-metallic material across a metal substrate during the hot water treatment, wherein molecules that migrate through water and deposit on the metal substrate to form the metal oxide nanostructures deposit on the neighboring non-metallic material and form a layer of the metal oxide nanostructures.

16. The method of claim 9, wherein the treatment condition comprises a temperature in a variety of ranges such that the hot water is liquid water at ambient temperatures, warm water below boiling point, boiling water, or steam at much higher temperatures.

17. The method of claim 9, wherein said treating the metallic material with the hot water is assisted by external physical and chemical factors including radiation, applied electric or magnetic fields, mechanical vibrations, and chemical additives.

18. The method of claim 17, wherein the radiation includes microwave, laser, ultraviolet and infrared light, and the chemical additives include metal salt and metal salt solution.

19. The method of claim 9, wherein the treated metallic material with the metal oxide nanostructures under the hot water process has a surface area to volume ratio that is higher than its pristine surface area to volume ratio of the metallic material.

20. A method for water treatment, comprising:
applying a photocatalytic material to water containing organic pollutants, wherein the photocatalytic material comprises the metal oxide nanostructures synthesized by the method of claim 8; and
exposing said water to light having ultraviolet (UV) wavelengths for an exposing time so as to photocatalytically degrade the organic pollutants in said water by the metal oxide nanostructures.

21. The method of claim 20, wherein the degradation of the organic pollutants is observed by measuring its absorbance, which is proportional to concentration of the organic pollutants in said water.

22. The method of claim 21, wherein the percentage degradation of the organic pollutants in the presence of the metal oxide nanostructures satisfies with the following equation.
A=((A₀−Aₜ)/A₀)×100,
where A₀ is the absorbance at the initial time, and Aₜ is the absorbance at the exposing time t.

23. The method of claim 20, wherein the metal oxide nanostructures are of a semiconductor.

24. The method of claim 23, wherein the metal oxide nanostructures comprise nanostructures of ZnO, TiO₂, CuO, Fe₂O₃, Al₂O₃, SnO₂, PbO, MgO, MoO₃, CdO, MnO₂, CoO₄, In₂O₃, V₂O₅, Bi₂O₃, Ta₂O₅, and/or Nd₂O₃.
